(19) United States
(12) Patent Application Publication
(10) Pub. No.: US 2020/0198584 A1
(43) Pub. Date: Jun. 25, 2020

(54) FASTENING DEVICE FOR A WINDSHIELD WIPER ACTUATION LINKAGE SYSTEM

(71) Applicant: VALEO SYSTÈMES D'ESSUYAGE, Le Mesnil Saint Denis (FR)

(72) Inventors: Nicolas KUCHLY, Issoire (FR); Pascal RENOUX, Issoire (FR); Robin VIARD, Issoire (FR)

(73) Assignee: Valeo Systèmes d'Essuyage, Le Mesnil Saint Denis (FR)

(21) Appl. No.: 16/619,708

(22) PCT Filed: May 11, 2018
(86) PCT No.: PCT/EP2018/062227

§ 371 Date: Dec. 5, 2019

(30) Foreign Application Priority Data
Jun. 9, 2017 (FR) 1755156

(51) Int. Cl. B60S 1/04; F16B 21/04

(52) U.S. Cl. CPC B60S 1/0447; F16B 21/04; B60S 1/045; B60S 1/0436

(57) ABSTRACT

Fastening device for a windshield wiper actuation linkage system, this device including a plate (32) intended to be fastened to a vehicle body (36) and at least one fastening member (34) intended to be inserted into a first orifice in said plate and an aligned second orifice in said body, said at least one fastening member being configured to be rotatable in said first and second orifices from a first, unlocking position to a second, locking position, and vice versa, characterized in that said plate comprises positioning means intended to cooperate in a form-fitting manner with complementary means of said body.

### TECHNICAL FIELD

The present invention concerns in particular a fastening device for a windshield wiper actuation linkage system and a method of using that kind of device.

### PRIOR ART

A motor vehicle is conventionally equipped with windshield wipers for washing the windshield and avoiding disturbance to the driver's view of their environment. These windshield wipers generally comprise a drive arm effecting an angular to-and-fro movement and elongate wiper blades in turn carrying wiper rubbers made from an elastic material. These rubbers rub against the windshield and evacuate water out of the field of view of the driver. The wipers are made in the form either, in a standard version, of articulated brackets that retain the wiper rubber at a number of discrete locations, imparting to it a curvature enabling it to espouse the curvature if any of the windshield, or, in a more recent “flat blade” version, a semi-rigid assembly that retains the wiper rubber over all its length thanks to one or more curvature spines enabling the wiper to be pressed onto the windshield without having to use brackets.

In both solutions the arm of each wiper is connected by its end opposite the wiper to a linkage system for driving it in rotation.

A linkage system conventionally comprises a link each longitudinal end of which is articulated to a crank constrained to rotate with a windshield wiper drive shaft, and more particularly its arm.

Each longitudinal end of the link carries a ball joint in which is mounted in ball joint fashion a crank peg fastened to one end of a crank an opposite end of which is fastened to a windshield wiper drive shaft. Each drive shaft is guided in rotation by a bearing that is carried by a support plate fixed to the body of the vehicle.

A plate of this kind of linkage system, such as the bearing support plate, may be fastened to the body by nut and bolt type means.

The invention proposes an improvement to this technology that is simple, effective and economical.

### SUMMARY OF THE INVENTION

The invention proposes a fastening device for a windshield wiper actuation linkage system, this device including a plate intended to be fastened to a vehicle body and at least one fastening member intended to be inserted into a first orifice in said plate and an aligned second orifice in said body, said at least one fastening member being configured to be rotatable in said first and second orifices from a first, unlocking position to a second, locking position, and vice versa, characterized in that said plate comprises positioning means intended to cooperate in a form-fitting manner with complementary means of said body.

Thus the invention proposes to combine the fastening of the plate by a rotatable member with positioning means facilitating fastening and guaranteeing optimum positioning of the parts. The fastening member, advantageously formed in one piece (that is to say with no attached nut or bolt for example) is configured to be movable from the unlocking position allowing demounting of the parts to the locking position and therefore fastening the parts, in particular the plate, to the body, and vice versa.

The device according to the invention may have one or more of the following features separately or in combination:
said plate is a support plate, in particular a bearing support plate,
said positioning means include at least one projecting stud configured to be engaged in an orifice of complementary shape in said body,
said positioning means include two studs substantially aligned on a common line with said first orifice,
said first orifice has a circular general shape,
said fastening member comprises a cylindrical body connected by one of its longitudinal ends to a holding means, preferably manual holding means,
the body is connected to said holding means by an external annular flange intended to bear on the plate and including at least one peg intended to cooperate by elastic clipping and/or engagement with at least one hole of complementary shape in said plate,
said body comprises two diametrally opposed grooves that are configured to cooperate by sliding with complementary means of said body,
each of said grooves includes an axial portion one end of which opens at a free longitudinal end of said body and an opposite end of which is connected to one end of a substantial circumferential portion of the groove,
said body comprises two diametrally opposite projecting ramps that are configured to cooperate by sliding with complementary means of said body,
each of said ramps includes an inclined portion one end of which opens at a free longitudinal end of said body and an opposite end of which is connected to one end of a substantially circumferential portion of the ramp.

The invention also concerns a windshield wiper actuation linkage system including at least one device as described hereinabove.

The present invention also concerns a combination including a vehicle body and a device as described hereinabove in which said body comprises at least one second orifice intended to be aligned with said first orifice and to receive said fastening member.

Said second orifice may comprise two semicircular openings the straight edges of which are separated from one another by a rectilinear strip of material intended to cooperate by sliding with said grooves.

Alternatively, said second orifice has a wrapped candy general shape the peripheral edges of which are intended to cooperate by sliding with said ramps.

The invention also concerns a method of using a device as described hereinabove, characterized in that it comprises:
a step of positioning the plate on a body so that said first and second orifices are aligned and said means cooperate with one another in form-fitting manner, and
a step of engagement and rotation of said or each fastening member in said first and second orifices from its first position to its second position.

### DESCRIPTION OF THE FIGURES

The invention will be better understood and other details, features and advantages of the invention will become apparent on reading the following description given by way of nonlimiting example and with reference to the appended drawings, in which:

FIG. 1 is a diagrammatic perspective view of a motor vehicle windshield wiper actuation linkage system in accordance with the prior art,

FIG. 2 is a diagrammatic perspective view of a motor vehicle windshield wiper actuation linkage system according to the invention,

FIG. 3 is a diagrammatic perspective view of a fastening member for the system from FIG. 2,

FIG. 4 is a diagrammatic perspective view of a body part from FIG. 2,

FIG. 5 is a diagrammatic perspective view of a support plate for the system from FIG. 2,

FIGS. 6a to 6d are diagrammatic perspective views of the system from FIG. 2 and show a number of steps in fastening that system and using the device according to the invention,

FIG. 7 is a diagrammatic perspective view in section of the member from FIG. 3,

FIGS. 8a and 8b are diagrammatic views of an end of the member from FIG. 3 engaged in the orifice in the body and respectively represent two distinct positions of that member,

FIG. 9 is another diagrammatic view of the end of the member from FIG. 3 in the locking position from FIG. 8b,

FIG. 10 is a diagrammatic perspective view of a variant embodiment of the fastening member for the system from FIG. 2,

FIG. 11 is a diagrammatic perspective view of another motor vehicle windshield wiper actuation linkage system according to the invention,

FIG. 12 is a diagrammatic perspective view of a body part from FIG. 11,

FIG. 13 is a diagrammatic perspective view of a support plate for the system from FIG. 11,

FIG. 14 is a diagrammatic perspective view of a fastening member for the system from FIG. 11,

FIGS. 15a to 15c are diagrammatic perspective view of the system from FIG. 11 showing a number of steps of fastening that system and of using the device according to the invention, and

FIG. 16 is a diagrammatic view of one end of the member from FIG. 14 in a locking position relative to the body.

### DETAILED DESCRIPTION

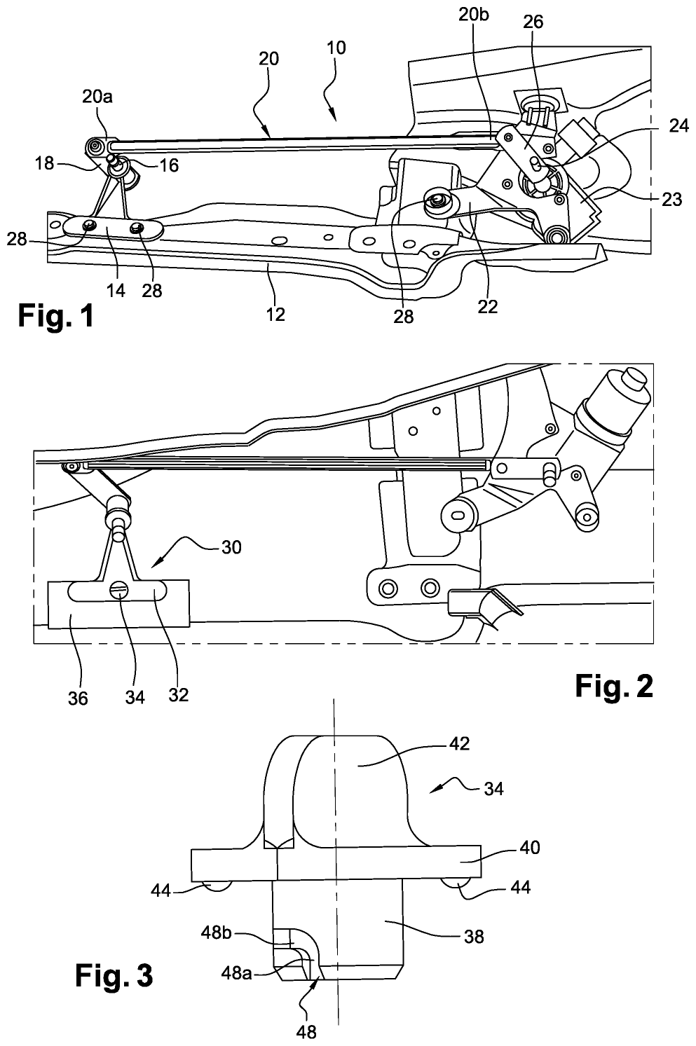

Refer first to FIG. 1 which represents a motor vehicle windshield wiper actuation linkage system 10.

The system 10 is typically fastened to the body 12 of the vehicle and comprises a plate 14 for supporting a bearing guiding rotation of a drive shaft 16 of a first windshield wiper that is not shown. This first windshield wiper conventionally comprises an arm for actuating a wiper blade, one longitudinal end of the arm being fastened to the shaft 16 and its opposite longitudinal end being connected to the wiper blade carrying a wiper rubber intended to wipe the windshield of the vehicle.

The shaft 16 is moreover constrained to rotate with one end of a crank 18 the other end of which is articulated to a first longitudinal end 20a of a link 20.

The system 10 comprises another plate 22 for supporting an electric gearmotor 23 the output shaft 24 of which is intended to drive a second windshield wiper. This second windshield wiper, not shown, is similar to that described above.

The output shaft 24 is also constrained to rotate with one end of a crank 26 the other end of which is articulated to a second longitudinal end 20b of the link 20.

In the prior art represented in FIG. 1, a plate of the system 10 such as the plate 14 or the plate 22 is fastened to the body 12 by conventional fastening means 28 for example of the nut and bolt type.

The invention proposes an improvement to this technology.

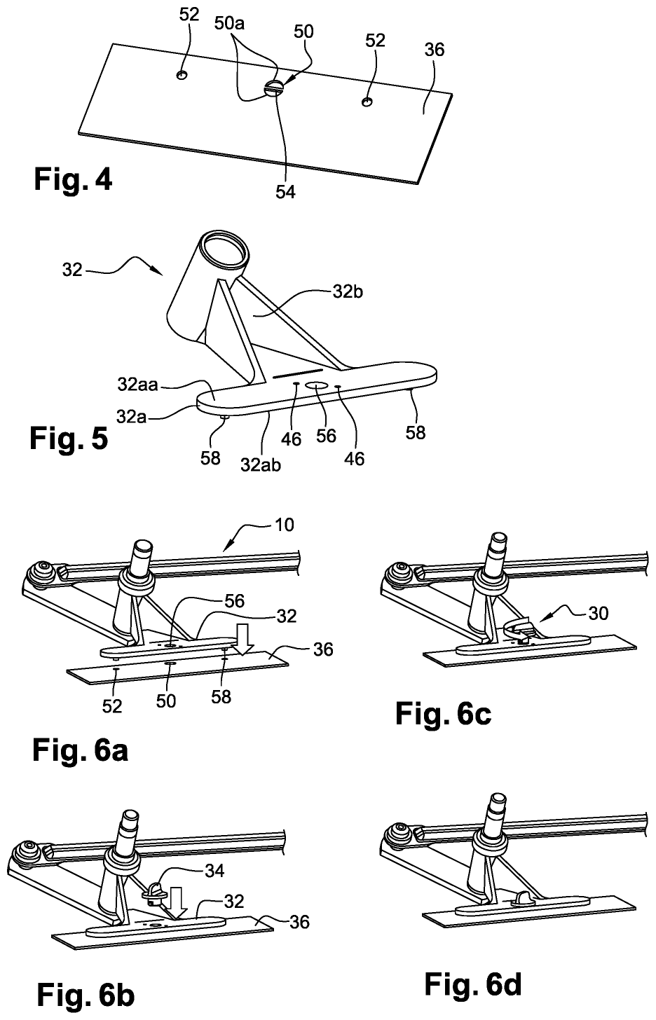

In accordance with a first embodiment represented in FIGS. 2 to 9, the invention proposes a fastening device 30 including a specific plate 32 visible in FIG. 5 and at least one fastening member 34 visible in FIG. 3. The device 30 is intended to cooperate with a specific body 36, or body portion, represented in FIG. 4.

Here the device 30 comprises only one member 34 but could include more of them. The member 34 comprises a cylindrical body 38 one longitudinal end of which, here the lower end, is free, and the other end of which is connected by an external annular flange 40 to a holding means 42, preferably manual holding means.

The flange 40 is intended to come to bear axially on the plate 32 and comprises on its lower surface at least one projecting peg 44 intended to cooperate by elastic clipping and/or engagement with a hole 46 in the plate 32. In the example represented the number of pegs 44 of the member 34 is equal to two. They are for example diametrally opposed relative to the longitudinal axis of the member 34 and its body. Here the pegs 44 have a part-spherical general shape.

Here the holding means 42 comprises a transverse wall that can be grasped by an operator in order to rotate the number 34 about its axis. It may be grasped by for example placing the thumb and the index finger of one hand on either side of the wall and gripping the wall between those fingers.

The body 38 of the member 34 includes two diametrally opposed grooves 48 that are configured to cooperate by sliding with complementary means of the body 36 to enable movement in rotation of the member 34 from a first, unlocking position to a second, locking position, and vice versa.

In the example represented each of the grooves 48 includes an axial portion 48a one end of which opens at a free longitudinal end of the body and an opposite end of which is connected to one end of a substantially circumferential portion 48b of the groove. Each groove therefore has in section the general shape of an L.

The body 34 may be cylindrical and solid or tubular.

The body 36 comprises orifices 50, 52. The orifice 50, here a central orifice, is intended to receive the member 34 and in particular its body 38. The orifices 52, here lateral orifices, are intended to receive studs 58 of the plate 32.

Here the orifices 50, 52 are aligned on a common line, the orifices 52 being situated on respective opposite sides of the orifice 50. Here the orifices 52 have a cylindrical general shape. The orifice 50 has a shape complementary to that of the member 34 and configured to cooperate with the member 34 in order to lock the assembly after rotation of the member 34.

Here the orifice 50 has a circular general shape crossed transversely by a strip 54 of material extending here along the aforementioned line. In other words, the orifice 50 comprises two semicircular openings 50a the straight edges of which are separated from one another by the rectilinear strip 54.

The strip 54 is intended to cooperate by sliding with the grooves 48 of the member 34. The strip 54 is therefore adapted to be engaged in the grooves 48 and to cooperate with its peripheral edges to go from an unlocking position to a locking position. In the unlocking position the member 34 has been moved in translation along its axis, in the orifice 50, so that the strip 54 is situated in the longitudinal portions 48a of the grooves 48 (FIG. 8a). In the locking position the member has been moved in rotation about the axis in the orifice 50 so that the strip 54 is situated in the circumferential portions 48b of the grooves 48 (FIGS. 8b and 9). The edges of the grooves 48 advantageously cooperate cam-fashion with the strip 54.

The plate 32 comprises a base 32a for fastening it to the body 36 and an arm 32b for supporting a bearing. The base 32a is substantially plane and comprises an upper face 32aa and a lower face 32ab. The lower face 32ab is intended to be applied to the body 36 and the upper face is intended to receive the member 34 and in particular its flange 40.

The plate 32 and in particular its base 32a comprises an orifice 56 for the member 34 to pass through, which here has a circular general shape. The orifices 50, 56 are intended to be aligned. The base 32a comprises on its upper face 32aa the aforementioned two holes 46 to receive the pegs 44. Here the holes 46 are diametrally opposed relative to the axis of the orifice 56. The base 32a further comprises on its lower face 32ab the aforementioned two studs 58 intended to be engaged in the orifices 52.

FIGS. 6a to 6d show steps of mounting or using the device for fastening a linkage system 10 to a vehicle body 36.

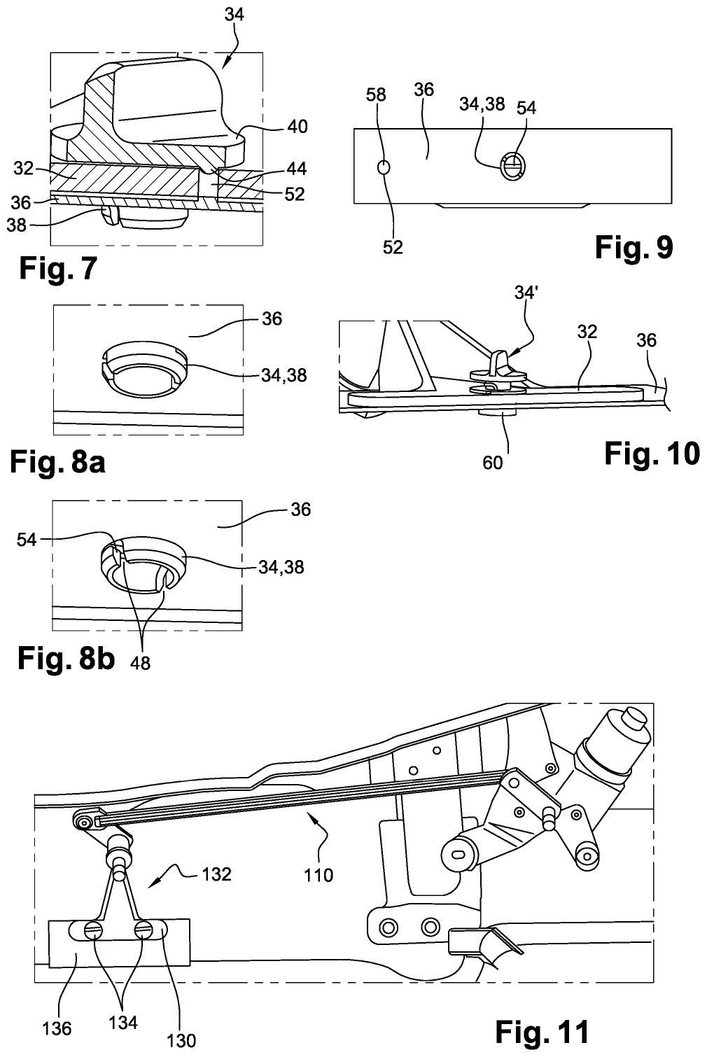

A first step consists in positioning the plate 32, connected or not to the system 10, on the body 36 (cf. arrow in FIG. 6a). To this end, the base 32a of the plate is applied to the body 36 and is positioned so that the studs 58 are engaged in the orifices 52. In this position the orifices 50, 56 are aligned and ready to receive the member 34 (cf. arrow in FIG. 6b). The member 34 is engaged therein by movement in axial translation as indicated above and is turned (cf. arrow in FIG. 6c) which, given the shape of the grooves 48 of the member and their cooperation with the strip 54 of material of the body, clamp the plate onto the body, as well as locking these two parts relative to one another. The angular extent or dimension of the circumferential portions 48b of the grooves 48 is determined to facilitate locking by an operative and so that at the end of travel the pegs 44 are engaged in the holes 46 in the plate 32 (cf. FIG. 7). Rotation of the member 34 between its extreme positions may therefore necessitate rotation by a quarter-turn about its axis.

FIG. 10 shows a variant embodiment in which the member 34′, similar that 34 described above, is engaged in an orifice of a part 60, such as a ring, mounted in the orifices of the body 36 and of the plate 32.

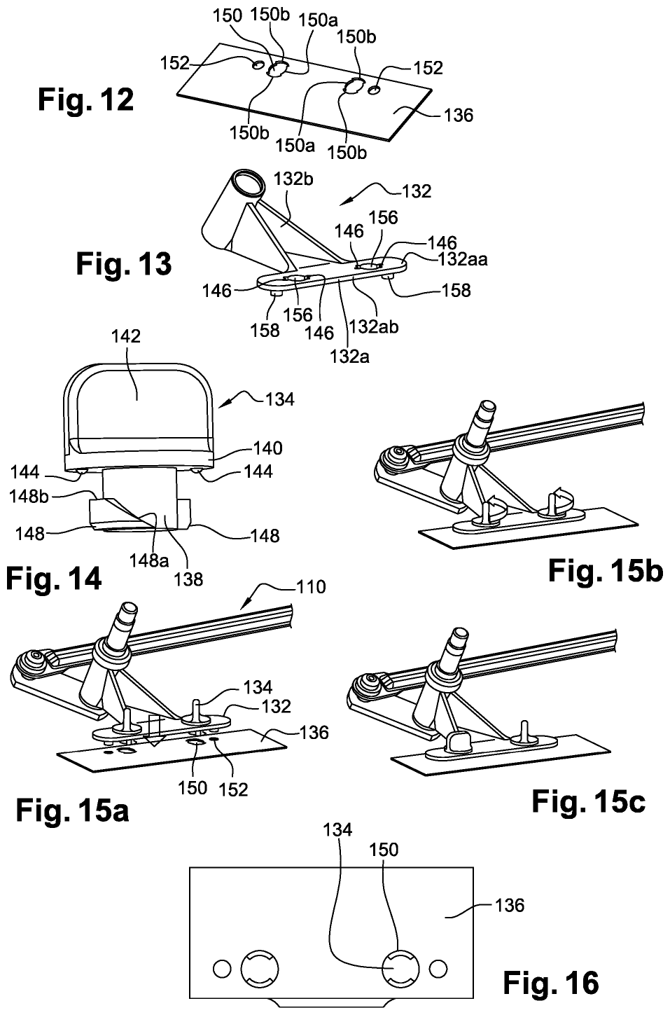

In accordance with another embodiment represented in FIGS. 11 to 16, the invention propose a fastening device 130 including a specific plate 132 visible in FIG. 13 and at least one fastening member 134 visible in FIG. 14. The device 130 is intended to cooperate with a specific body 136, or body portion, represented in FIG. 12.

Here the device 130 comprises two members 134 but could include more of them. Each member 134 comprises a cylindrical body 138 one longitudinal end of which, here the lower end, is free, and the other longitudinal end of which is connected by an external annular flange 140 to a holding means 142, preferably manual holding means.

The flange 140 is intended to come to bear axially on the plate 132 and comprises on its lower face at least one projecting peg 144 intended to cooperate by elastic clipping and/or engagement with a hole 146 in the plate 136. In the example represented the number of pegs 144 of the member 134 is equal to two. They are for example diametrally opposed relative to the longitudinal axis of the member 134 and its body. Here the pegs 144 have a part-spherical general shape.

Here the holding means 142 comprises a transverse wall that may be grasped by an operative in order to rotate the member about its axis. It may be grasped for example by placing the thumb and the index finger of one hand on respective opposite sides of the wall and gripping the wall between them.

The body 138 of the member 134 includes two diametrally opposed projecting ramps 148 that are configured to cooperate by sliding with complementary means 136 of the body to enable movement in rotation of the member 134 from a first, unlocking position to a second, locking position, and vice versa.

In the example represented each of the ramps 148 includes an inclined portions 148a one end of which opens at a free longitudinal end of the body and an opposite end of which is connected to one end of a substantially circumferential portion 148b of the ramp.

The body 134 may be cylindrical and solid or tubular. The axial distance between the portions 148b of the ramps and the flange 140 corresponds to the cumulative thicknesses of the base 132a of the plate 132 and of the body 136.

The body 136 comprises orifices 150, 152. The orifices 150 are intended to receive the members 134, and in particular their bodies 138. The orifices 152, here lateral orifices, are intended to receive the studs 158 of the plate 132.

Here the orifices 150, 152 are aligned on a common line. Here the orifices 152 have a cylindrical general shape. The orifices 150 have a shape complementary to the member 134 and configured to cooperate with the member 134 in order to lock the assembly after starting rotation of the member 134.

In the example represented each orifice 150 has a wrapped candy general shape and comprises a hollowed out central part and two diametrally opposed hollowed out sectors. The central part of each orifice 150 is intended to receive the cylindrical or tubular part of a body 138 and its sectors are intended to receive the ramps 148 of the body 138 during movement in axial translation of the member 134 in the orifice 150.

The ramps 148 are intended to cooperate by sliding with the peripheral edges of the orifices 150, which extend between the opened out sectors of those orifices. Rotating the member 134 enables movement from an unlocking position to a locking position. In the unlocking position the member has been moved in translation along its axis in the orifice 150 so that the ramps 148 pass through the opened out sectors of the orifice 150. In the locking position the member has been placed in rotation about the axis in the orifice 150 so that the inclined portions 148a and then the circumferential portions 148b of the ramps 148 slide and are accommodated under the peripheral edges of the orifices 150 lying between the opened out sectors of those orifices (cf. FIG. 16). The ramp 148 advantageously cooperates with these edges cam-fashion.

The plate 132 comprises a base 132a for fastening it to the body 136 and an arm 132b for supporting a bearing. The base 132a is substantially plane and comprises an upper face 132aa and a lower face 132ab. The lower face 132ab is intended to be applied to the body 136 and the upper face is intended to receive the member 134 and in particular its flange 140.

The plate 132 and in particular its base 132a comprises two orifices 156 for the respective members 134 to pass through. Each orifice 156 has a shape similar to that of the orifices 150. The base 132a comprises on its upper face, for each orifice 156, the aforementioned two holes 146 or notches to receive the pegs 144. Here the holes 146 are diametrally opposed relative to the axis of the corresponding orifice 156. The base 132a further comprises on its lower face the aforementioned two studs 158 intended to engage in the orifices 152.

FIGS. 15 to 15c show steps of mounting or using the device for fastening a linkage system 110 to a vehicle body 136.

A first step consists in positioning the plate 132, connected or not to the system 110, on the body 136 (cf. arrow in FIG. 15a). To this end the base 132a of the plate is applied to the body and is positioned so that the studs 158 are engaged in the orifices 152. In this position the orifices 150, 156 are aligned and ready to receive the members 134. Each member 134 is engaged in the orifices by movement in axial translation as indicated above and is turned (cf. arrow in FIG. 15b) which, given the shape of the ramps 148 of the member and their cooperation with the body 136, leads to clamping of the plate onto the body and locking of these parts to one another. The angular extent or size of the ramps 148 is determined to facilitate locking by an operative and so that at the end of travel the pegs 144 are engaged in the holes 146 in the plate 132 (cf. FIG. 7). The rotation of each member 134 between its extreme positions may therefore necessitate a quarter-turn rotation about its axis.

In the example shown the member 34, 34′, 134 may be made of plastic. The plate 32, 132 may then be made of metal. Alternatively and conversely, the member may be made of metal and the plate of plastic. This combination of materials may be beneficial in allowing some plastic deformation of the member or of the plate on rotation of the member and locking the fastening.

As mentioned above, the device may comprise a varying number of fastening members. That number depends for example on the size of the member and the forces to which it is intended to be exposed in operation.

1. A fastening device for a windshield wiper actuation linkage system, the device comprising:
a plate configured to be fastened to a vehicle body; and
at least one fastening member configured to be inserted into a first orifice in said plate and an aligned second orifice in said body,
said at least one fastening member being rotatable in said first and second orifices from a first, unlocking position to a second, locking position, and vice versa,
wherein said plate comprises positioning means configured to cooperate in a form-fitting manner with complementary means of said body.

2. The device as claimed in claim 1, in which said plate is a bearing support plate.

3. The device as claimed in claim 1, in which said positioning means include at least one projecting stud configured to be engaged in an orifice of complementary shape in said body.

4. The device as claimed in claim 3, wherein said positioning means include two studs substantially aligned on a common line with said first orifice.

5. The device as claimed in claim 1, wherein said first orifice has a circular general shape.

6. The device as claimed in claim 1, wherein said fastening member comprises a cylindrical body connected by one of its longitudinal ends to a holding means.

7. The device as claimed claim 6, wherein the body is connected to said holding means by an external annular flange configured to bear on the plate and including at least one peg that cooperates by elastic clipping and/or engagement with at least one hole of complementary shape in said plate.

8. The device as claimed in claim 6, wherein said body comprises two diametrally opposed grooves that are configured to cooperate by sliding with complementary means of said body.

9. The device as claimed in claim 8, in which each of said grooves includes an axial portion one end of which opens at a free longitudinal end of said body and an opposite end of which is connected to one end of a substantial circumferential portion of the groove.

10. The device as claimed in claim 6, wherein said body comprises two diametrally opposite projecting ramps that are configured to cooperate by sliding with complementary means of said body.

11. The device as claimed in claim 10, in which each of said ramps includes an inclined portion one end of which opens at a free longitudinal end of said body and an opposite end of which is connected to one end of a substantially circumferential portion of the ramp.

12. A windshield wiper actuation linkage system including at least one device as claimed in claim 1.

13. An assembly, comprising: a vehicle body; and a device (30, 130) as claimed in claim 1, wherein said body comprises at least one second orifice configured to be aligned with said first orifice and to receive said fastening member.

14. The assembly as claimed in claim 13, wherein said fastening member comprises a cylindrical body connected by one of its longitudinal ends to a holding means, wherein the cylindrical body comprises two diametrally opposed grooves that are configured to cooperate by sliding with complementary means of said cylindrical body, and wherein said at least one second orifice comprises two semicircular openings the straight edges of which are separated from one another by a rectilinear strip of material intended to cooperate by sliding with said grooves.

15. The assembly as claimed in claim 13, wherein said fastening member comprises a cylindrical body connected by one of its longitudinal ends to a holding means, wherein said cylindrical body comprises two diametrally opposite projecting ramps that are configured to cooperate by sliding with complementary means of said body, and wherein said at least one second orifice has a wrapped candy general shape the peripheral edges of which cooperate by sliding with said ramps.

16. A method of using a device as claimed in claim 1, the method comprising:
positioning the plate on a body so that said first and second orifices are aligned and said means cooperate with one another in form-fitting manner; and
engagement and rotation of said or each fastening member in said first and second orifices from its first position to its second position.
